(19) United States
(12) Patent Application Publication
(10) Pub. No.: US 2026/0236580 A1
(43) Pub. Date: Aug. 13, 2026

(54) INTERCEPTION AND PREVENTION OF MALICIOUS ACTIONS OF ARTIFICIAL INTELLIGENCE MODELS

(71) Applicant: XILINX, INC., San Jose, CA (US)

(72) Inventors: Sarunas Kalade, Glasgow (GB); Shane Fleming, Swansea (GB); Graham Schelle, Louisville, CO (US)

(21) Appl. No.: 19/047,973

(22) Filed: Feb. 7, 2025

(51) Int. Cl. G06F 21/56; G06N 3/0475; G06N 3/096

(52) U.S. Cl. CPC G06F 21/566; G06N 3/0475; G06N 3/096; G06F 2221/033

(57) ABSTRACT

A trained machine learning model intercepts a subset of activation values of a generative artificial intelligence inference model executing at a processing system and classifies the subset of activation values as malicious based on the subset of activation values meeting one or more criteria. The trained machine learning model triggers an exception in response to the intercepted subset of activation values being classified as malicious.

### BACKGROUND

Generative artificial intelligence (genAI) inferencing such as large language model (LLM) inferencing involves utilizing a pre-trained model to generate output text (e.g., responses to questions, text to complete a sentence, a summarization of text, etc.) based on input text (e.g., a question, an initial segment of a sentence, text to be summarized, etc.). Many genAI inference models execute on cloud deployments and user data in the form of queries is sent to remote servers. Because the use of such cloud-run genAI inference models can expose user information, locally-run genAI inference models are becoming increasingly popular due to privacy and confidentiality concerns. GenAI inference models that are fine-tuned for various tasks are proliferating; however, not all locally-run fine-tuned genAI inference models are safe to use, as some such models have been designed or corrupted to spread misinformation or output unsafe code to compromise security systems.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to execute a trained machine learning model to intercept and prevent malicious actions of a generative artificial intelligence model executing at the processing system in accordance with some embodiments.

FIG. 2 is a block diagram of a trained machine learning model evaluating intermediary activations of a generative artificial intelligence model and triggering an exception in response to detecting malicious intent in accordance with some embodiments.

FIG. 3 is a diagram illustrating a user interface for enabling and selecting classification criteria for one or more trained machine learning models to intercept and prevent malicious actions of a generative artificial intelligence inference model in accordance with some embodiments.

FIG. 4 is a flow diagram illustrating a method for evaluating intermediary activations of a generative artificial intelligence model and triggering an exception in response to detecting malicious intent in accordance with some embodiments.

### DETAILED DESCRIPTION

Generative artificial intelligence (genAI) inferencing such as large language model (LLM) inferencing or multi-modal inferencing involves utilizing a pre-trained model to generate output text or graphics (e.g., responses to questions, text to complete a sentence, a summarization of text, graphical representations, etc.) based on input text (e.g., a question, an initial segment of a sentence, text to be summarized, etc.). LLMs and other genAI inference models are typically characterized by their vast number of parameters (ranging from a few million parameters to several billion). The parameters include weights that are trained during a training phase, after which the weights are stored at an internal or external memory. The trained weights are subsequently accessed for application during an inference phase.

The execution of genAI models such as LLMs typically includes a prefill phase and a decode phase. The prefill phase operates on a vector of words in order to understand the context, i.e., the informational background or the set of circumstances surrounding a specific piece of data, event, or computational process. In the decode phase, the model generates output, typically one token (e.g., word) at a time, by leveraging the context established in the preceding phase or phases. During this decode phase, the model iteratively utilizes the contextual information accumulated from a prefill phase to predict or generate the subsequent element in a sequence. This phase is characterized by the model's application of its learned parameters and the structural intricacies of its architecture—such as attention blocks and Multi-Layer Perceptron (MLP) blocks—to infer the most probable subsequent token based on the provided context. The decode phase is operative for the model's generative tasks. Attention blocks are computational units that selectively focus on different portions of the input data, generally allowing the model to weigh the importance of those portions differently when processing information and MLP blocks are one or more layers that perform a series of weighted inputs, bias additions, and non-linear activations to transform input data.

GenAI inference models (also referred to herein as genAI models) are supported by artificial neural networks, which analyze input data to generate outputs. Each neuron in each layer of a neural network is associated with a number of inputs having values (e.g., between zero and one) that represent information such as color or text. Each neuron performs a gradient calculation based on the input(s) times a weight plus a bias. If the gradient calculation meets a threshold, the neuron activates and transfers its value to a neuron in the next layer of the network. During a training phase, the weights are trained (i.e., adjusted) and stored at a memory. During an inference phase, the trained weights are accessed from the memory and applied to new inputs.

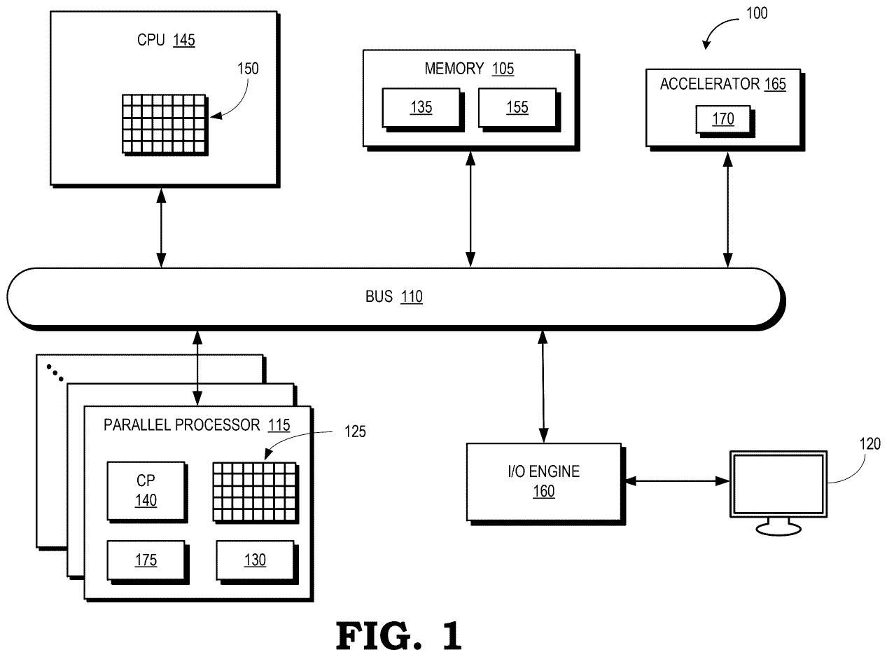

FIGS. 1-4 illustrate a trained machine learning model for intercepting a subset of activation values of a genAI model executing at a processing system and predicting whether the genAI model will engage in malicious activity such as outputting unsafe code or providing misinformation or offensive material. For example, in some implementations the trained machine learning model detects the injection of malicious code that a user might copy-paste and compromise the processing system, enables prevention of minors being exposed to inappropriate language or images, and/or prevents users from being exposed to misinformation. If the trained machine learning model determines that the genAI model will likely engage in malicious activity based on the intercepted subset of activation values, the trained machine learning model triggers an exception (e.g., sends a warning or halts execution of the genAI model) to prevent the malicious activity from occurring.

In some implementations, the genAI model executes at a parallel processor such as a graphics processing unit (GPU) and the trained machine learning model executes at a low-power accelerator such as a neural processing unit (NPU). Whereas the genAI model may generate activations having up to billions of parameters, the trained machine learning model is trained to introspect the innerworkings of the genAI model by intercepting a relatively small subset of activation values of intermediary layers of the genAI model (e.g., 10 or 20 activation values) that have been identified as being likely to influence the genAI model to engage in malicious behavior. Thus, the trained machine learning model requires significantly fewer computational resources than the genAI model and can execute on local resources such as an NPU, an integrated GPU, or a dedicated silicon chip.

Although hundreds of genAI models exist, each genAI model generally belongs to one of a small number of families of genAI models. Each family of genAI models has similar specific intermediary layers that tend to include activation values that disproportionately contribute to malicious behavior. Thus, in some implementations, a driver identifies a family of genAI models to which the genAI model executing at the processing system belongs. Based on the identified family of genAI models, the trained machine learning model intercepts the subset of activation values from the specific intermediary layers that tend to include activation values that disproportionately contribute to malicious behavior.

The trained machine learning model is trained to classify the subset of activation values as malicious based on the subset of activation values meeting one or more sets of criteria. In some implementations, the criteria relate to one or more categories of malicious behavior. For example, one set of criteria relates to code safety (e.g., malware), another set of criteria relates to misinformation, another set of criteria relates to offensive material, and yet another set of criteria relates to child-friendliness in some implementations. Thus, in some implementations, a trained machine learning model is trained to prevent a single category of malicious behavior, and more than one such trained machine learning model may execute at the accelerator to prevent multiple categories of malicious behavior. In other implementations, a single trained machine learning model is trained to prevent multiple categories of malicious behavior.

In some implementations, the trained machine learning model is enabled in response to the genAI model executing at the processing system. In other implementations, a user interface allows a user to selectively enable the trained machine learning model or to select the conditions under which is enabled. For example, the user interface allows the user to select to enable the trained machine learning model when a genAI model that has not been verified as safe (e.g., an unsigned genAI model) is executing at the processing system.

FIG. 1 is a block diagram of a processing system 100 configured to execute a trained machine learning model to intercept and prevent malicious actions of a generative artificial intelligence model executing at the processing system in accordance with some embodiments. The processing system 100 is generally designed to execute sets of instructions or commands to carry out tasks on behalf of an electronic device, such as a desktop computer, laptop computer, server, smartphone, tablet, game console, and the like.

The processing system 100 includes or has access to a memory 105 or other storage component that is implemented using a non-transitory computer readable medium, such as dynamic random access memory (DRAM). The processing system 100 also includes a bus 110 to support communication between entities implemented in the processing system 100, such as the memory 105. In certain embodiments, the processing system 100 includes other buses, bridges, switches, routers, and the like, which are not shown in FIG. 1 in the interest of clarity.

The processing system 100 includes one or more parallel processors 115 that are configured to render images for presentation on a display 120. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 115 can render objects to produce pixel values that are provided to the display 120. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 115 is also used for general-purpose computing. For instance, the parallel processor 115 can be used to implement machine learning algorithms such as one or more implementations of a neural network as described herein. In some cases, operations of multiple parallel processors 115 are coordinated to execute a machine learning algorithm, such as if a single parallel processor 115 does not possess enough processing power to run the machine learning algorithm on its own.

The parallel processor 115 implements multiple processing elements (also referred to as compute units) 125 that are configured to execute instructions concurrently or in parallel. The parallel processor 115 also includes an internal (or on-chip) memory 130 that includes a local data store (LDS), caches, registers, or buffers utilized by the compute units 125. The parallel processor 115 can execute instructions stored in the memory 105 and store information in the memory 105 such as the results of the executed instructions. The parallel processor 115 also includes a command processor 140 that receives task requests and dispatches tasks to one or more of the compute units 125.

The processing system 100 also includes a central processing unit (CPU) 145 that is connected to the bus 110 and communicates with the parallel processor 115 and the memory 105 via the bus 110. The CPU 145 implements multiple processing elements (also referred to as processor cores) 150 that are configured to execute instructions concurrently or in parallel. The CPU 145 can execute instructions such as program code 155 stored in the memory 105 and the CPU 145 can store information 135 in the memory 105 such as the results of the executed instructions.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the parallel processor 115, or the CPU 145.

In operation, the CPU 145 issues commands to the parallel processor 115 to initiate processing of a kernel that represents the program instructions that are executed by the parallel processor 115. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups (also termed thread groups) that are executed on different compute units 125. For example, the command processor 140 can receive these commands and schedule tasks for execution on the compute units 125.

In some embodiments, the parallel processor 115 implements a graphics pipeline that includes multiple stages configured for concurrent processing of different primitives in response to a draw call. Stages of the graphics pipeline in the parallel processor 115 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

In the illustrated example, the parallel processor 115 executes a genAI model 175 that implements neural network having a number of layers to execute prefill and decode phases of the genAI model 175. As used herein, a layer in a neural network is a hardware-or software-implemented construct in a processing system, such as processing system 100. In various embodiments, such a layer may perform one or more operations via processing circuitry of the processing system 100 to serve as a collection or group of interconnected neurons or nodes, arranged in a structure that can be optimized for execution on one or more parallel processors (e.g., parallel processors 115) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data —for example, raw data input into an input layer or the transformed data passed between hidden layers such as intermediary layers. This transformation process involves the use of an output weight matrix, which is held in memory (e.g., memory 105 or internal memory 130) and manipulated by the central processing unit (CPU) 145 and/or the parallel processors 115.

In some instances, such layers may be distributed across multiple processing units within a system. For instance, different layers or groups of layers may be executed on different compute units 125 within a single parallel processor 115, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

To facilitate the prevention of malicious behavior by the genAI model 175 executing at one or more of the parallel processors 115, the processing system 100 includes a trained machine learning model 170 that intercepts a subset of activation values from intermediary layers of the genAI model 175 and classifies the subset of activation values as malicious in response to the subset of activation values meeting one or more sets of criteria. The trained machine learning model 170 is implemented as a Deep Neural Network (DNN) or a Multi-Layer Perceptron (MLP) in some embodiments. In the illustrated example, the trained machine learning model 170 executes at an accelerator 165. In some implementations, the accelerator 165 requires less power than the one or more parallel processors 115 and is implemented as a neural processing unit (NPU), an integrated GPU, or a dedicated silicon chip.

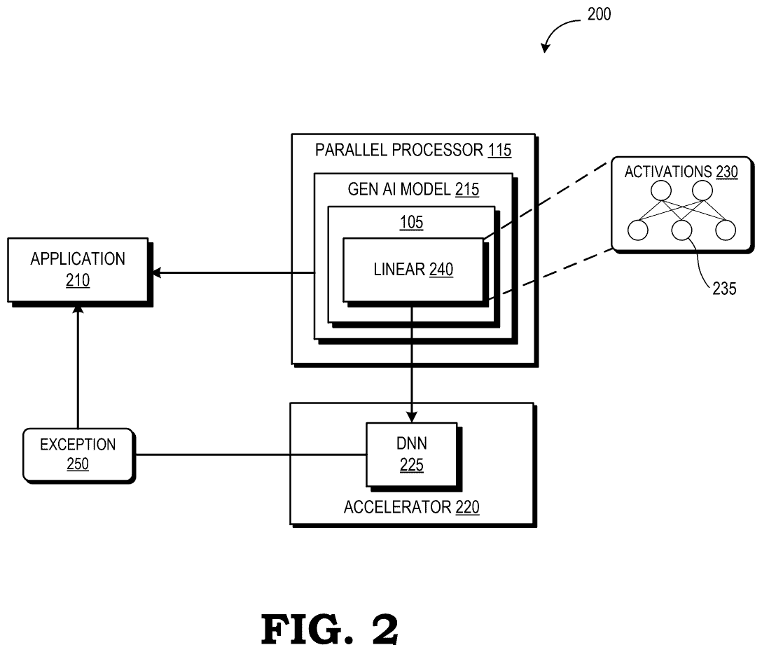

FIG. 2 is a block diagram 200 of the trained machine learning model evaluating intermediary activations 230 of a genAI model 215 and triggering an exception 250 in response to detecting malicious intent in accordance with some embodiments. In the illustrated example, an application 210 executing at the processing system runs the genAI model 215 that is executing at the parallel processor 115. The trained machine learning model is implemented as a Deep Neural Network (DNN) 225 executing at an accelerator 220. The DNN 225 has access to a shared memory such as memory 105 that stores the intermediary activations 230 of the genAI model 215 and acts as a classifier that uses the intermediary layer outputs (activations 230) as inputs.

In some implementations, the DNN 225 is trained to intercept specific intermediary layers of each of a plurality of families of genAI models that are likely to include activation values that could cause the genAI model to engage in malicious behavior. A driver (not shown) identifies the genAI model 215 that is executing at the parallel processor 115 and informs the DNN 225 of the identity of the genAI model 215 and a family of genAI models to which the genAI model 215 belongs. For example, there are currently approximately a relatively small number of major families of LLMs, and the DNN 225 is trained to know which specific intermediary layers and which specific neurons (activation values) of the intermediary layers are responsible for inciting malicious behavior by LLMs belonging to each of the major families of LLMs. Thus, by the driver identifying the genAI model 215 and the family of genAI models to which the genAI model 215 belongs and providing the information to the DNN 225 via firmware or software running at the processing system 100, the DNN 225 can predict whether the genAI model 215 is likely to engage in malicious behavior by accessing only the subset of activation values 230 that are most likely to be responsible for inciting malicious behavior by the genAI model 215.

The subset of activations 230 are included in a linear subspace 240 of the activation space in some implementations, based on the understanding that genAI models such as LLMs represent features and concepts as linear directions in activation space. Further, certain behaviors by LLMs are mediated by a one-dimensional (linear) subspace such as linear subspace 240.

The DNN 225 accesses the memory 105 (or other memory at which the activation values are stored) and intercepts the subset of activation values that have been identified as likely to be responsible for inciting malicious behavior by the genAI model 215. In some implementations, the DNN 225 intercepts the subset of activation values using a programming mechanism such as function or callable object such as a hook (e.g., a PyTorch forward hook or backward hook). The DNN 225 compares the subset of activation values to one or more sets of criteria that classify activation values as indicative of malicious intent corresponding to one or more categories of malicious behavior (e.g., code safety, misinformation, offensiveness, and child-friendliness). In the illustrated example, the DNN 225 identifies activation value 235 from the subset of activation values 230 as meeting the criteria for malicious intent in one or more of the categories of malicious behavior. The DNN 225 therefore classifies the intercepted subset of activation values as malicious.

In response to classifying the intercepted subset of activation values as malicious, the DNN 225 triggers an exception 250. In the illustrated example, the DNN 225 sends a signal indicating the exception 250 to the application 210. In some implementations, the signal includes information fed back to the application 210 for further evaluation. In some implementations, the signal is a kernel signal sent at the level of an operating system signal. Based on the signal, in some implementations the application 210 halts execution of the genAI model 215, thus preventing the malicious intent of the genAI model 215 from manifesting in, e.g., the display of misinformation or inappropriate or harmful material.

Because the DNN 225 is trained to intercept on a subset of the activation values 230 of the genAI model 215, the DNN 225 is significantly smaller (e.g., orders of magnitude smaller) than the genAI model 215 in some implementations. The DNN 225 runs ambiently in the background at the accelerator 220, which may be implemented as a low-power NPU.

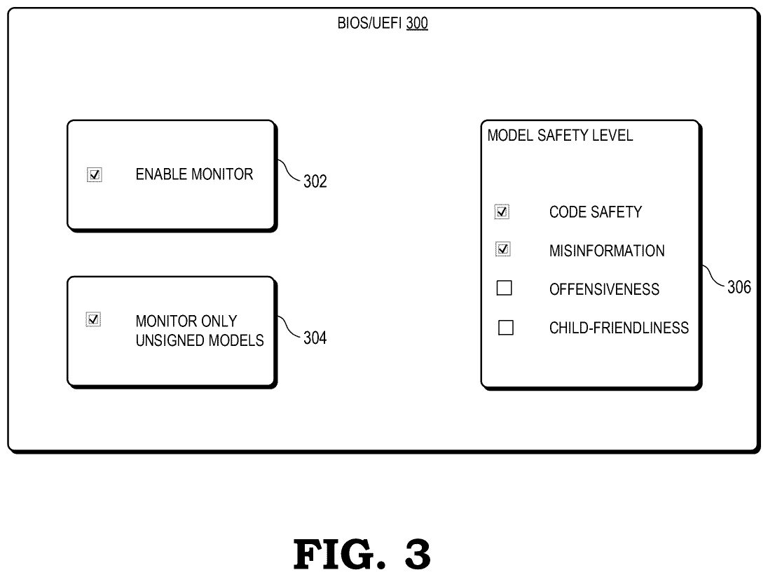

FIG. 3 is a diagram illustrating a user interface 300 for enabling and selecting categories of malicious behavior 306 for one or more trained machine learning models to intercept and prevent malicious actions of a genAI model in accordance with some embodiments. In the illustrated example, the user interface 300 is a Basic Input/Output System (BIOS) or Unified Extensible Firmware Interface (UEFI) that connects the firmware of the processing system 100 to its operating system (OS). In some embodiments, the user interface 300 is implemented at a firmware level (e.g., ROCm level) and provides access to the accelerator 220 running the DNN 225.

The user interface 300 allows a user to selectively enable a trained machine learning model such as the DNN 225 to monitor the intermediary layer activations of a genAI model such as genAI model 215 for malicious intent as the genAI model 215 is running. Thus, in response to the user selecting to enable monitoring 302, the DNN 255 is enabled to introspect the running genAI model 215 intermediary layer activations for malicious intent.

The user interface 300 further allows the user to selectively monitor only unsigned genAI models 304. Thus, depending on the power and bandwidth constraints of the processing system and the user's preference, the user may select to enable the DNN 255 only to monitor genAI models that are executing at the one or more parallel processors 115 that have not been verified for safety. It is worth noting, however, that safety verifications are based on static testing and may not necessarily prevent malicious behavior in response to runtime prompts. Thus, if power and bandwidth constraints permit, a user may select to monitor even those genAI models that have been verified for safety (i.e., signed genAI models), in addition to monitoring unsigned genAI models.

The user interface 300 further includes categories of malicious behavior 306 that the user can select for monitoring by one or more trained machine learning models. In the illustrated example, the categories of malicious behavior 306 include code safety, misinformation, offensiveness, and child-friendliness. In some implementations, a single trained machine learning model is trained to classify malicious behavior in multiple categories. In other implementations, each of a plurality of trained machine learning models are trained to classify malicious behavior in a single category, and multiple single-category trained machine learning models execute at one or more accelerators 220.

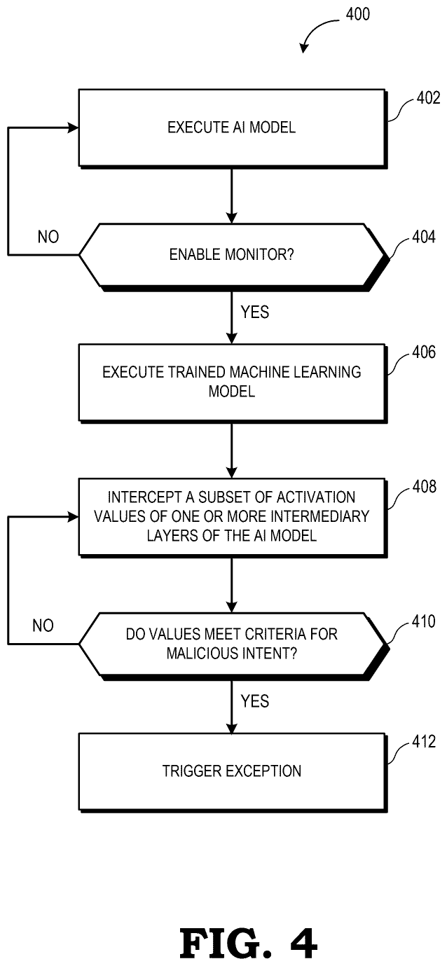

FIG. 4 is a flow diagram 400 illustrating a method for evaluating intermediary activations of a generative artificial intelligence model and triggering an exception in response to detecting malicious intent in accordance with some embodiments. The method may be implemented at a processing system such as processing system 100 and begins at block 402.

At block 402, the processing system executes a genAI model such as genAI model 215, which executes at one or more parallel processors 115. The genAI model 215 implements neural network having a number of layers to execute prefill and decode phases of the genAI model 215. Each layer processes and transforms input data such as raw data input into an input layer or the transformed data passed between hidden layers such as intermediary layers.

At block 404, a trained machine learning model 175 such as DNN 225 is selectively enabled. In some implementations, the DNN 225 is enabled in response to the genAI model 215 executing at the processing system 100. In other implementations, the DNN 225 is enabled in response to a user input, e.g., to a user interface such as user interface 300. If, at block 404, the trained machine learning model is not enabled, the method flow continues back to block 402. If the trained machine learning model is enabled, the method flow continues to block 406.

At block 406, the processing system executes one or more trained machine learning models 175. For example, in some implementations, the processing system executes the DNN 255 at a low-power accelerator such as accelerator 220 or at a NPU. In some implementations, the DNN 255 is enabled to classify multiple categories of malicious behavior.

At block 408, the DNN 255 intercepts a subset of activation values of one or more intermediary layers of the genAI model 215. The DNN 225 identifies the subset of activation values to intercept based on an identification of the family of genAI models to which the genAI model 215 belongs. Using a hook or other software mechanism, the DNN 225 intercepts the subset of activation values 230 from a shared memory, such as memory 105, to which both the genAI model 215 and the DNN 225 have access.

At block 410, the DNN 255 compares the intercepted subset of activation values 230 to one or more sets of criteria for each category of malicious behavior that the DNN 225 has been trained and enabled to classify. In some implementations, the one or more sets of criteria include indicating an intention to violate code safety, indicating an intention to convey misinformation, indicating an intention to display offensive material, and indicating an intention to display material that is inappropriate for children. If, at block 410, the DNN 255 determines that the intercepted subset of activation values 230 do not meet the criteria for malicious intent for any of the enabled categories of malicious behavior, the method flow continues back to block 408.

If, at block 410, the DNN 255 determines that one or more of the intercepted subset of activation values 230 (e.g., activation value 235) meets the criteria for malicious intent for one or more of the enabled categories of malicious behavior, the method flow continues to block 412.

At block 412, the DNN 255 triggers an exception. In some implementations, the exception includes sending a signal to an application executing at the processing system indicating that the genAI model 215 is likely to engage in malicious activity. The application halts execution of the genAI model 215 in response to receiving the signal, thus preventing the genAI model 215 from engaging in the malicious activity.

In some embodiments, the apparatus and techniques described above are implemented in a system including one or more integrated circuit (IC) devices (also referred to as integrated circuit packages or microchips), such as the processing system described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]--is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
executing a generative artificial intelligence (genAI) inference model at one or more parallel processors of a processing system;
executing one or more trained machine learning models at one or more accelerators of the processing system;
intercepting, at the one or more trained machine learning models, a subset of activation values of one or more intermediary layers of the genAI inference model from a memory shared by the one or more parallel processors and the one or more accelerators; and
triggering, at the one or more trained machine learning models, an exception in response to the one or more trained machine learning models classifying the intercepted subset of activation values as malicious.

2. The method of claim 1, wherein the one or more accelerators operate at a lower power than the one or more parallel processors.

3. The method of claim 1, wherein the one or more trained machine learning models are trained based on a family of genAI inference models to which the genAI inference model belongs.

4. The method of claim 3, wherein the one or more intermediary layers of the genAI inference model from which the subset of activation values is intercepted are based on the family of genAI inference models to which the genAI inference model belongs.

5. The method of claim 1, wherein the genAI inference model has a first size and the one or more trained machine learning models have a second size smaller than the first size.

6. The method of claim 1, wherein the exception comprises at least one of sending a signal to an application executing at the processing system and halting execution of the genAI inference model.

7. The method of claim 1, wherein the one or more trained machine learning models are configured to classify the intercepted subset of activation values by classifying the intercepted subset of activation values as one or more of: indicating an intention to violate code safety, indicating an intention to convey misinformation, indicating an intention to display offensive material, or indicating an intention to display material that is inappropriate for children.

8. The method of claim 1, further comprising:
selectively enabling execution of the one or more trained machine learning models in response to a user input.

9. The method of claim 1, further comprising:
selectively enabling execution of the one or more trained machine learning models based on the genAI inference model being unsigned.

10. A processing system, comprising:
one or more parallel processors configured to execute a generative artificial intelligence (genAI) inference model; and
one or more accelerators configured to execute one or more trained machine learning models to:
intercept a subset of activation values of one or more intermediary layers of the genAI inference model from a memory shared by the one or more parallel processors and the one or more accelerators; and
trigger an exception in response to the one or more trained machine learning models classifying the intercepted subset of activation values as malicious.

11. The processing system of claim 10, wherein the one or more accelerators operate at a lower power than the one or more parallel processors.

12. The processing system of claim 10, wherein the one or more trained machine learning models are trained based on a family of genAI inference models to which the genAI inference model belongs.

13. The processing system of claim 10, wherein the genAI inference model has a first size and the one or more trained machine learning models have a second size smaller than the first size.

14. The processing system of claim 10, wherein the exception comprises at least one of sending a signal to an application executing at the one or more parallel processors and halting execution of the genAI inference model.

15. The processing system of claim 10, wherein the one or more trained machine learning models are configured to classify the intercepted subset of activation values by classifying the intercepted subset of activation values as one or more of: indicating an intention to violate code safety, indicating an intention to convey misinformation, indicating an intention to display offensive material, or indicating an intention to display material that is inappropriate for children.

16. The processing system of claim 10, wherein the one or more accelerators are to selectively enable execution of the one or more trained machine learning models in response to a user input.

17. The processing system of claim 10, wherein the one or more accelerators are to selectively execute the one or more trained machine learning models based on the genAI inference model being unsigned.

18. A non-transitory computer readable medium embodying a set of executable instructions, the set of executable instructions to manipulate at least one processor of a processing system to:
execute one or more trained machine learning models to:
intercept a subset of activation values of one or more intermediary layers of a generative artificial intelligence (genAI) inference model executing at one or more parallel processors of a processing system from a memory shared by the one or more parallel processors and the at least one processor; and
trigger an exception in response to the one or more trained machine learning models classifying the intercepted subset of activation values as malicious.

19. The non-transitory computer readable medium of claim 18, wherein the exception comprises at least one of sending a signal to an application executing at the one or more parallel processors and halting execution of the genAI inference model.

20. The non-transitory computer readable medium of claim 18, wherein the one or more trained machine learning models are configured to classify the intercepted subset of activation values by classifying the intercepted subset of activation values as one or more of: indicating an intention to violate code safety, indicating an intention to convey misinformation, indicating an intention to display offensive material, or indicating an intention to display material that is inappropriate for children.
